(19) United States
(12) Patent Application Publication
(10) Pub. No.: US 2022/0350945 A1
(43) Pub. Date: Nov. 3, 2022

(54) BIOMIMETIC TOPOLOGY OPTIMIZATION AND ROBOTIC FABRICATION OF 3D-PRINTED HIGH-PERFORMANCE CONSTRUCTION SYSTEMS

(71) Applicant: University of Tennessee Research Foundation, Knoxville, TN (US)

(72) Inventor: Maged Samir Guerguis, Knoxville, TN (US)

(21) Appl. No.: 17/734,846

(22) Filed: May 2, 2022

Related U.S. Application Data
(60) Provisional application No. 63/182,420, filed on Apr. 30, 2021.

(51) Int. Cl. G06F 30/23; G06F 30/17; G06F 30/13; G06F 30/12

(52) U.S. Cl. CPC G06F 30/23; G06F 30/17; G06F 30/13; G06F 30/12; G06F 2111/10

(57) ABSTRACT

The present subject matter relates to systems and methods for designing a construction component for a building in which a biomimetic topology optimization algorithm is applied to a building design to define a structure of one or more construction component of the building. Such construction components can be fabricated using an additive manufacturing method.

### PRIORITY CLAIM

The present application claims the benefit of 63/182,420, filed Apr. 30, 2022, the disclosure of which is incorporated herein by reference in its entirety.

### TECHNICAL FIELD

The subject matter disclosed herein relates generally to methods and systems for building construction. More particularly, the subject matter disclosed herein relates to methods and systems for building construction that employ topological optimization and that can be used with additive manufacturing approaches.

### BACKGROUND

Current conventional construction methods contribute to a significant amount of total waste in the United States, which has major negative financial and environmental impacts on the American economy. Additive manufacturing (AM), also known as three-dimensional (3D)-printing, offers innovative alternatives to conventional construction techniques that could provide quicker, safer, and more sustainable options. Despite the efforts to advance the current building construction, AM methods that have transformed other industries have not been used at the full-scale application in the building's construction practices and have been limited to small applications.

### SUMMARY

In accordance with this disclosure, systems and methods for designing a construction component for a building are provided. In one aspect, a method of designing a construction component for a building is provided. The method can include generating a building design that includes one or more construction component and applying a biomimetic topology optimization algorithm to the building design to define a structure of the one or more construction component.

In another aspect, a system for designing a construction component for a building, the system including at least one processor and a computing platform implemented using the at least one processor. The computing platform is configured for preparing, analyzing, interpreting, and/or viewing one or more construction component, or design thereof, using biomimetic topology optimization.

In another aspect, a non-transitory computer readable medium has stored thereon executable instructions that when executed by at least one processor of a computer cause the computer to perform steps comprising: preparing, analyzing, interpreting, and/or viewing a construction component, or design thereof, using biomimetic topology optimization.

Although some of the aspects of the subject matter disclosed herein have been stated hereinabove, and which are achieved in whole or in part by the presently disclosed subject matter, other aspects will become evident as the description proceeds when taken in connection with the accompanying drawings as best described herein below.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The features and advantages of the presently disclosed subject matter will be more readily understood from the following detailed description which should be read in conjunction with the accompanying drawings that are given merely by way of explanatory and non-limiting example, and in which:

FIG. 1A is a scanning electron micrograph image of bird bone tissue.

FIG. 1B is an image of a 3D printed scale model of a topologically optimized house according to an embodiment of the presently disclosed subject matter.

FIGS. 2A-2E are a series of schematics showing topology-based housing design approaches.

FIGS. 3A-3E are a series of schematics showing a traditional wood framing in comparison to the topologically optimized model: (FIG. 3A) standard wood framing of the house prototype; and (FIGS. 3B-3E) assembled topologically optimized planar surfaces of a house model prepared using a method of the presently disclosed subject matter.

FIG. 4A is a perspective side view of a stiffness mesh representing material distribution of a topologically optimized panel framing structure of a wall panel in accordance with the presently disclosed subject matter.

FIG. 4B is a perspective side view of a low-polygon mesh of a topologically optimized panel framing structure of a wall panel in accordance with the presently disclosed subject matter.

FIG. 4C is a perspective side view of a smooth non-uniform B-spline (NURBS) surface of a topologically optimized panel framing structure of a wall panel in accordance with the presently disclosed subject matter.

FIG. 4D is a perspective side view of a finite element stress analysis of a topologically optimized panel framing structure of a wall panel in accordance with the presently disclosed subject matter.

FIG. 4E is a perspective side view of a 3D-printed scale model of a topologically optimized panel framing structure of a wall panel in accordance with the presently disclosed subject matter.

FIG. 5 is a multi-step flow schematic of a process and system of the presently disclosed subject matter implementing an advanced robotic fabrication platform.

FIG. 6 is a perspective side view of a robotic fabrication system that is used to produce a panel.

FIG. 7A is an exploded perspective side view of elements of a panel produced in accordance with a process and system of the presently disclosed subject matter.

FIG. 7B is perspective side view of a panel produced in accordance with a process and system of the presently disclosed subject matter.

FIG. 8 is a diagram illustrating an example system for design-to-fabrication workflow of topologically optimized robotically controlled additively building component, in accordance with the presently disclosed subject matter.

### DETAILED DESCRIPTION

The presently disclosed subject matter provides systems and methods for designing a construction component for a building. In one aspect, the presently disclosed subject matter provides a method of designing a construction component by applying a biomimetic topology optimization algorithm to the building design. Topology optimization is a computational form-finding method of determining the best possible forms based on optimal material distribution within a design space with a particular set of boundary conditions, including loads, supports, and other design constraints. In some embodiments, through an iterative process, the presently disclosed subject matter provides an algorithm that refines material distribution within a model volume boundary to meet a particular set of performance goals to maximize the performance of the structural system by increasing stiffness while reducing the weight by reserving material only in areas of high stress.

In some embodiments, the presently disclosed subject matter provides robotically controlled AM and computational design platforms that change the construction industry by developing new processes to design and fabricate full-scale high-performance 3D-printed building components. The presently disclosed subject matter can thus provide novel, fully integrated robotic fabrication approaches to construction driven by the material economy and can transform current construction practices.

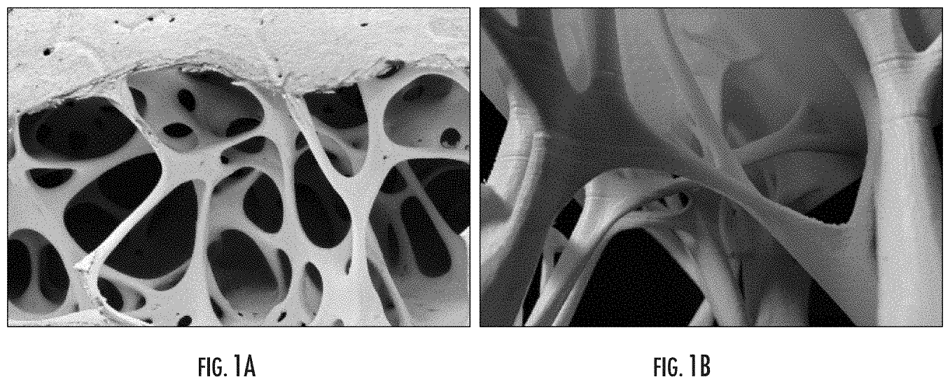

In some embodiments, the presently disclosed subject matter implements one or more biomimetic principles found in nature, such as for animals, birds, and/or plants where optimal strength-to-weight ratios are significant to ensure the efficient use of limited material resources. Referring to FIG. 1A, it has been recognized that the internal bone structure of bird bone tissue is optimized to provide support and strength while maintaining minimal weight. In a similar way, building geometries can be optimized as shown in FIG. 1B to resemble the organic forms of such a natural bone structure. As Wolff's law states that animal bone varies in densities based on loads applied on it, computational form-finding morphologies of topology optimization follow the same principles that drives the weight reduction of the bird skeletal structure. Both structures need to be stiff towards applied surface pressure to resist longitudinal bending, therefore resulting in a similar distribution of the internal structural elements.

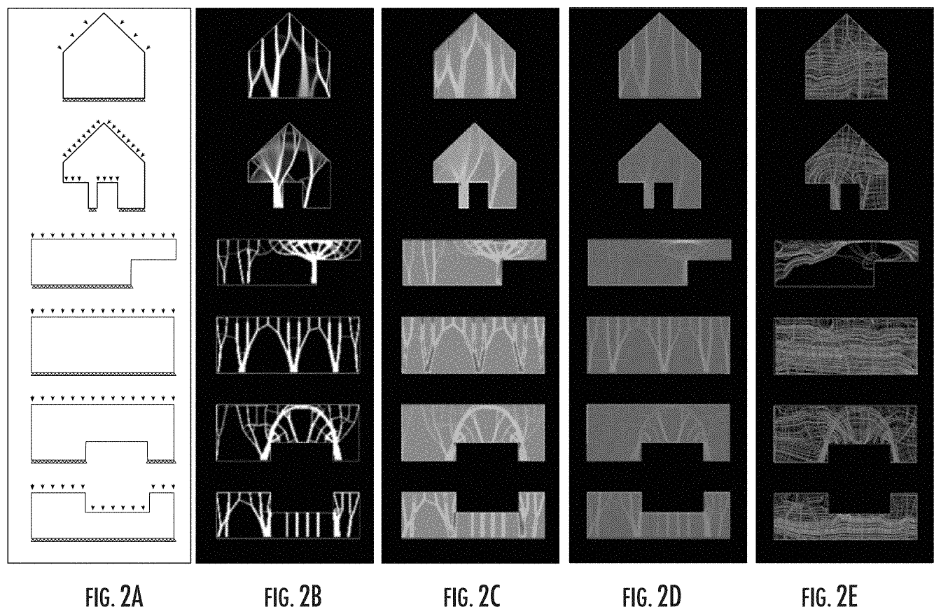

Referring to FIGS. 2A-2E, the influence of varying load scenarios of a house prototype was tested to maximize stiffness while reducing weight through optimal material distribution. FIG. 2A illustrates a model load distribution with respect to each planar surface of a building. Based on this load distribution, a topologically optimized planar load across each surface can be identified, such as is shown in FIG. 2B. This optimized load can be identified by analysis of a variety of load cases. As shown in FIGS. 2C through 2E, the load cases can include dead loads such as walls, floors, roofs, fixed service equipment, which act vertically; live loads such as weight of occupants, furniture, and supplies, which act vertically; and lateral wind loads, which act horizontally.

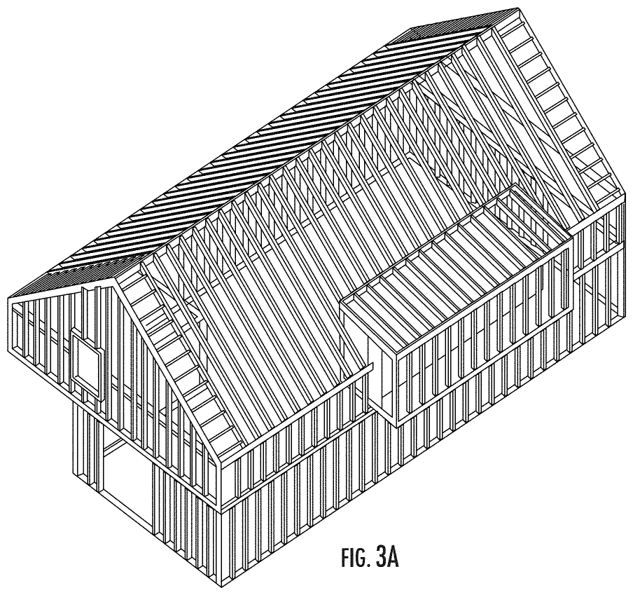

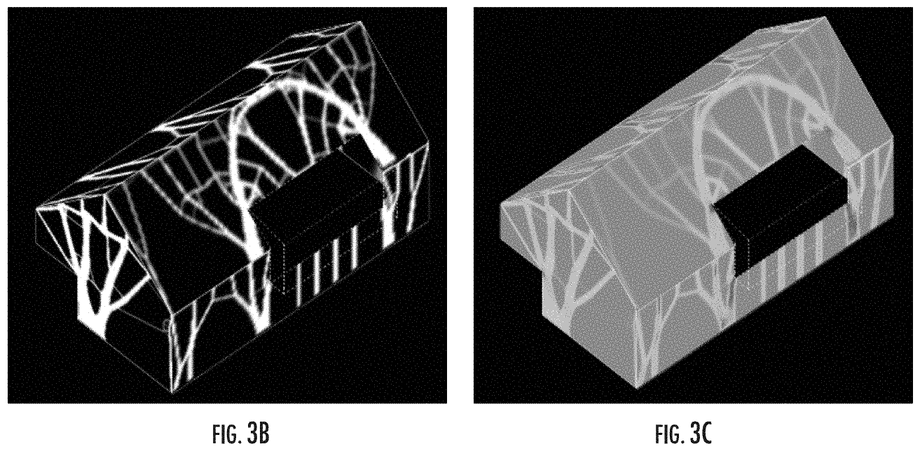

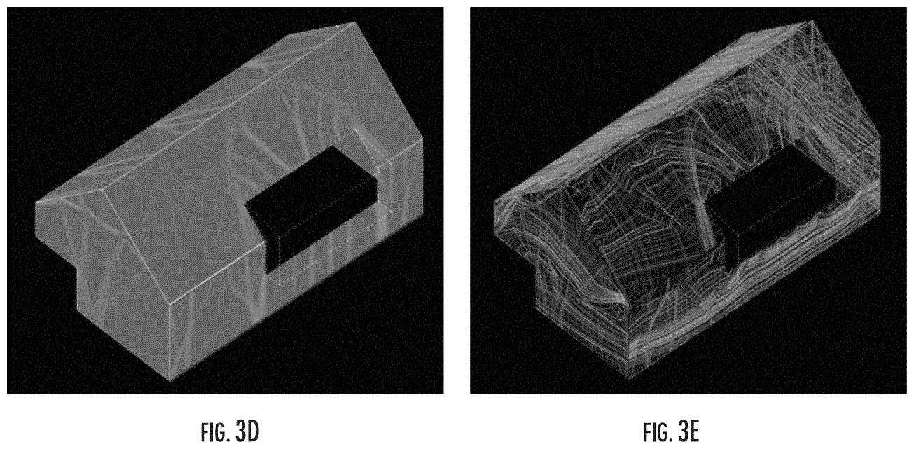

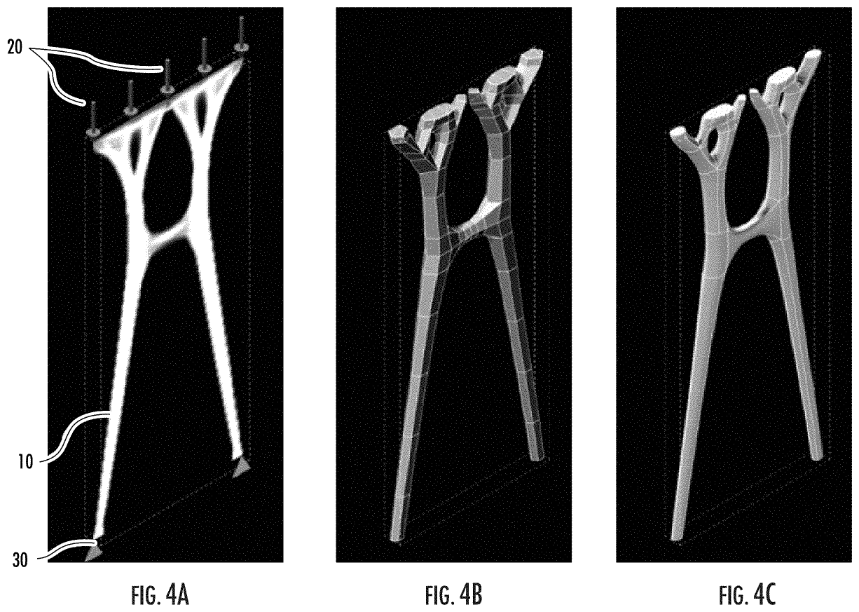

Based on these principles, all of the construction components can be assembled together to produce an optimized building design. As illustrated in FIGS. 3A-3C, traditional wood framing is shown in comparison to the topologically optimized model. FIG. 3A shows a standard wood framing of the house prototype, whereas FIGS. 3B through 3E show various characteristics of an assembled topologically optimized planar surfaces of the house model. FIG. 3B shows optimized stiffness factor, FIG. 3C shows Von Mises stress, FIG. 3D shows principal stress, and FIG. 3E shows principal stress lines. Each optimized roof and wall surface is joined at the corners to a main structural frame of the house.

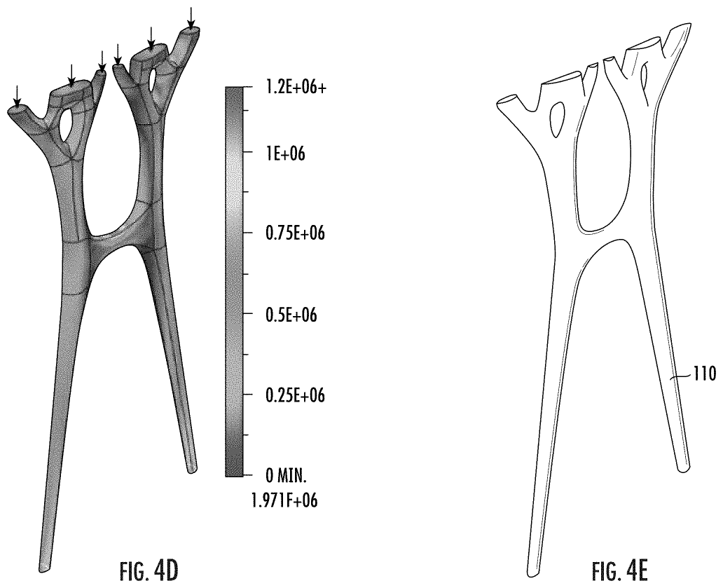

To produce these structures, in one aspect, the presently disclosed subject matter provides a design-to-fabrication workflow of a topologically optimized construction component for a building. In some embodiments, the workflow begins by producing a designed object model 10, which in some embodiments can be generated using Computer-Aided Design (CAD) modeling program. As shown in FIG. 4A, in some embodiments, the object model 10 is prepared using a stiffness mesh representing material distribution in a wall panel, and the shape of the wall panel can be further modeled using a low-polygon mesh (See, e.g., FIG. 4B) and/or a smooth non-uniform B-spline (NURBS) surface model (See, e.g., FIG. 4C). The discrete volume of the model 10 can be subjected to a topology optimization algorithm with a set of boundary conditions to determine the best possible forms based on optimal material distribution. In some embodiments, such boundary conditions can include loads 20, supports 30, and/or other design constraints. Other constraints include voids and cuts such as windows, doors, and ventilation openings.

Furthermore, as discussed above, the optimization algorithm can implement one or more biomimetic principles found in nature, such as by replicating structures commonly found in animals, birds, and/or plants where optimal strength-to-weight ratios are significant to ensure the efficient use of limited material resources. In some embodiments, the optimized designs resemble natural bone structure similar to the bird skull's according to scanning electron micrograph (SEM) shown in FIG. 1A. The computational topology optimization results can be compared to nature's design evolutionary processes outcome, but with a significant difference—it occurs in a fraction of the time due to the applied efficient optimization process.

Through an iterative process, the algorithm refines material distribution within the model volume to meet a specific set of performance goals and/or maximize the performance of the structural system by increasing stiffness while reducing the weight by reserving material only in areas of high stress. The primary goal is to minimize structural weight subject to mechanical stresses and deflection constraints.

In some embodiments, the topologically optimized models are generated based on paths between fixed constraints and the applied load on the volume boundary, including preserved regions, voids, and obstacle geometry in 3D space. The process of topology optimization minimizes the compliance of the elastic structure subject to constraints on the available material while maximizing stiffness. In some embodiments, the iterative algorithm uses a numerical method for determining optimal material distribution. In some embodiments, the structural material is redistributed gradually toward the optimal design outcome through an iterative process that involves modeling the design boundary, gradient computations, and mathematical programming-based optimization updates, as shown in FIG. 4A.

In this implementation, the elasticity equations are solved using finite element and sparse direct solvers. For example, in some embodiments, a multi-resolution finite element mesh volume shown in FIG. 4D represents the design field, and the design update is performed using gradient-based criteria. The design process starts with defining boundary volume, load case definitions, and constraints including initial, preserved and obstacle constraints. The topology optimization algorithm takes into consideration stress distribution through an iterative process. During the process of the deformation finite element (FE) simulation, the material of the structure develops some resistance against the deformation. When the structure's material takes over the influence of the load, the design becomes stable. The internal resistance that the body develops against the load is referred to as stress. Each iteration evaluates areas of high and low stress within the defined volume boundary. In areas in which stress is below a predetermined threshold value (i.e., “low-stress” areas), the algorithm gradually removes material, and correspondingly preserves material in areas in which stress is above the threshold value (i.e., “high-stress” areas) while avoiding obstacle parts.

The process goes through different iterations until all the design criteria with a specified targeted factor of safety have been fulfilled. Thus, the process can be completed to identify an optimal shape for a construction component 110 as shown in FIG. 4E.

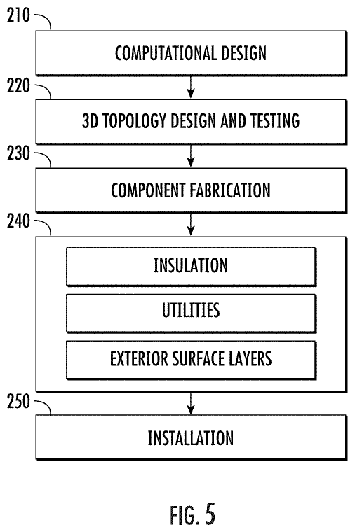

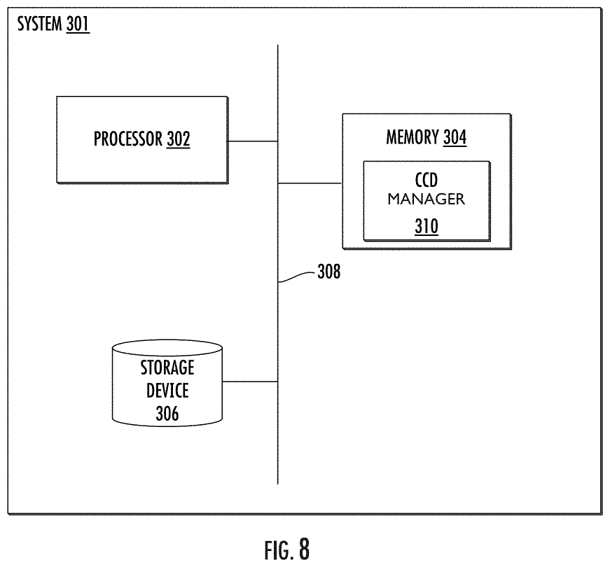

In another aspect, the design-to-fabrication workflow can be extended to integrate multiple construction components and other additional construction components. This workflow is an example for the manufacturing and mass customization and production of prefabricated high-performance building components. FIG. 5 is a flow chart illustrating an example process for the design-to-fabrication workflow according to an embodiment of the subject matter described herein. In some embodiments, the design-to-fabrication workflow, generally designated 200, depicted in FIG. 5 may be an algorithm, program, and/or script (e.g., a CCD manager as shown in FIG. 8) stored in memory that, when executed by a processor, performs the steps recited in blocks 210-250.

As shown in FIG. 5, the design-to-fabrication workflow 200 begins with a computational design step 210 to produce the designed object model as discussed above. In an optimization step 220, the topology optimization algorithm is applied to the discrete volume of the model with a set of boundary conditions to determine the best possible forms based on optimal material distribution. Based on the optimization, the optimal form for the construction component is identified, and the component can be produced in a fabrication step 230. In some embodiments, the fabrication of the construction component can involve implementing the construction component design using additive manufacturing (AM) methods and systems. AM, or 3D-printing, is based on an additive, layer-by-layer, substantially waste-free process allowing the generation of complex geometries directly from digital models. The qualities of AM, such as its ability to fabricate complex geometries with high levels of accuracy and construction automation, make it well suited to produce topologically-optimized designs. Despite its advantages, AM in construction has been limited to small scale porotypes and has not yet been implemented at large scale building construction practices.

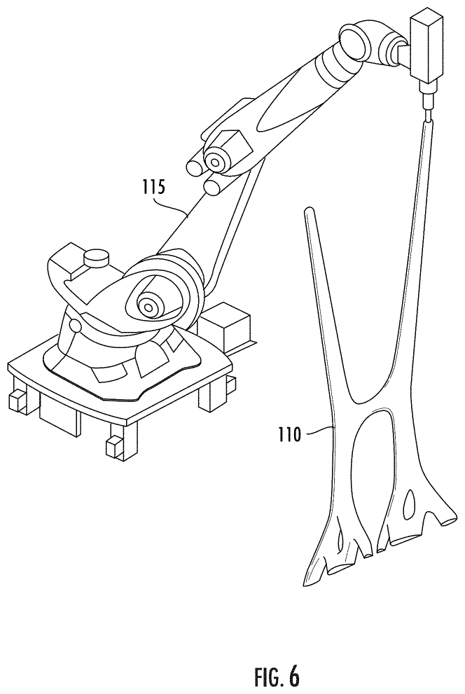

When used with the presently disclosed systems and methods, however, additive manufacturing techniques can be used to help provide a sustainable alternative to the current structural framing used in construction. In particular, the design-to-fabrication workflow discussed above can produce a topologically-optimized construction component using novel biodegradable composites, such as bamboo composites. In addition, such structures can be produced at a large scale beyond the limitations of current AM methods. In this regard, the method can be used with any large-scale additive manufacturing, including but not limited to Big Area Additive Manufacturing (BAAM) three-axis systems that extrude melted fiber reinforced polymer composites on a heated platform or large scale six-axis robotic arm with polymer-based pellet feed Fused Deposition Modeling (FDM) end effector extruder. FIG. 6 illustrates an embodiment in which a robot with an extruder arm 115 can be used to fabricate a construction component 110 using such methods. In embodiments in which the robotic arm is used, for example, a wide range of movement is offered that facilitates the production of more complex parts. In some embodiments, the optimized model can be translated to a sequential path slicer for constructing each segment to determine the extruder movement sequence.

Any of a variety of materials can be used that can be extruded through an aperture, that become fluid with a range of temperatures and then solidify, and/or that can be added layer-by-layer similar to Gas metal arc (MIG) welding. Examples of such materials can be used to achieve similar results, including but not limited to ceramic, cementitious, foam, metallic, polymer, clay, wax, epoxies, thermoset, and thermoplastic materials. In some particular embodiments, however, the additive manufacturing employs a recycled additive. In particular, in some embodiments, the recycled additive comprises a recycled bamboo product and/or a recycled wood product. For example, a bamboo-reinforced Acrylonitrile Butadiene Styrene (ABS) pellet or a Wood Fiber-Reinforced PLA Pellets can be used, each of which is a recycled, biodegradable, and more sustainable option and can provide strong, lightweight alternatives to traditional construction materials. Bamboo Fiber-Reinforced Polylactic Acid (PLA) pellets can also be used since bamboo fiber is hydrophobic (repels water), rot proof, anti-bacterial, anti-allergic and is a good fire resistant. Additionally, bamboo fiber provides excellent resistance to compression and flexion and is naturally biodegradable. Bamboo Fiber-Reinforced PLA pellets material properties includes 1.04 g/cm³ density, 32 MPa tensile strength, and 51 MPa flexural strength.

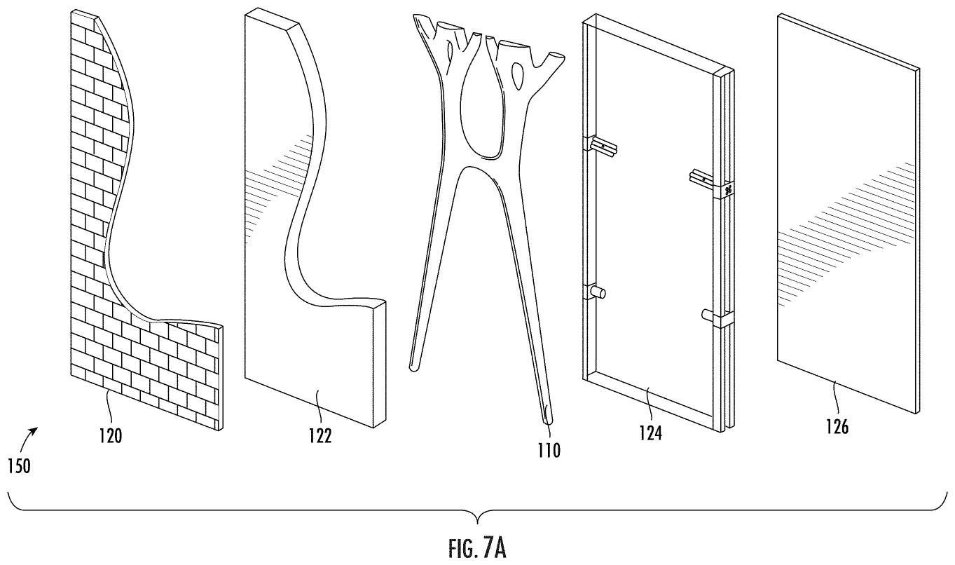

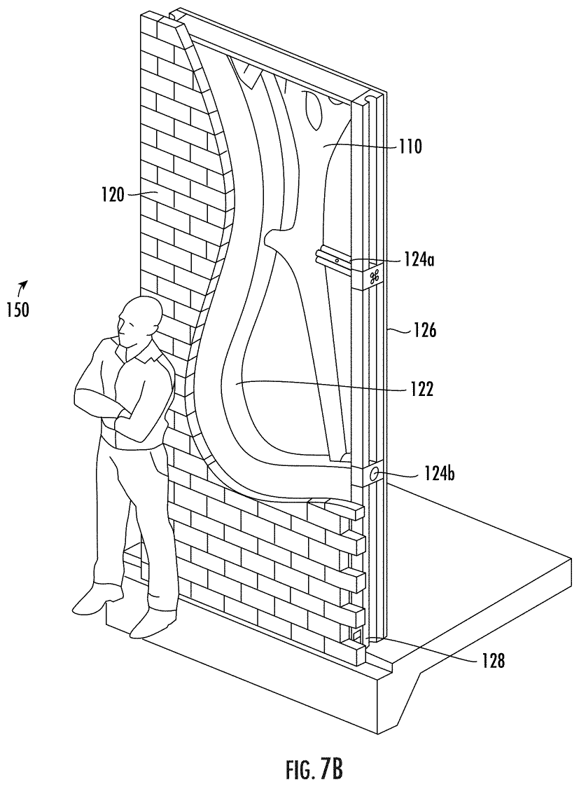

Further, the design-to-fabrication workflow 200 can include the fabrication of one or more additional construction components in an accessory construction step 240. In some embodiments, the high-performance 3D-printed construction system can further incorporate one or more additional construction components to the construction component to provide a vertically integrated building subassembly for the building, generally designated 150. Referring to FIGS. 7A and 7B, in some embodiments, in addition to the topologically optimized framing structure, such additional construction components can include an exterior cladding layer 120 (e.g., brick or masonry), an insulation layer 122, an integrated utility conduit system 124 (e.g., electric conduits 124a, wall cavity for water pipes 124b), and an interior cladding layer 126, although those having ordinary skill in the art will recognize that any of a range of further integrated structures can further be included, including but not limited to air and moisture barriers and further insulation and/or cladding layers.

In some embodiments, the one or more additional construction components are themselves prepared by additive manufacturing. For example, filler material such as polymeric insulation foam can be 3D-printed in the cavity spaces to serve as the insulation layer 122, and finish materials can also be applied. In this way, different smaller parts can be combined together into a single print. This approach allows for efficient use of the material and eliminates the need for smaller component assembly. Additionally, in some embodiments, the final fabricated part can incorporate a microchip 128 that stores building component information such as location within overall structure of the building (e.g., using augmented reality), R-Value, and load capacity.

Finally, in some embodiments, a robotic arm grip end effector can be used to precisely place one or more exterior cladding layer. For example, concrete can be applied by shotcrete or pumping to the exterior, gypsum can be applied to the interior face of the structure, and/or many other interior and exterior finishes can be used.

One of the significant advantages of this innovative design-to-fabrication workflow is that the final model requires virtually no post-processing and can thus be ready for slicing and Geometric Code (G-Code) generation for robotic arm movement path and 3D-printing. The topologically optimized 3D-printed structure can result in 20-40% weight savings compared to standard wood framing and ultimately significant material reduction.

The robotically controlled additive manufacturing and computational design platform improves the construction industry by providing new processes to design, develop, and fabricate full scale, high-performance, structural systems, and building envelopes. The presently disclosed subject matter provides strong, lightweight alternatives to traditional materials. The presently disclosed subject matter provides a novel, fully integrated approach to construction driven by the material economy and transforms the current construction practices.

In some embodiments, the presently disclosed subject matter provides a fully integrated robotic fabrication approach to construction driven by the material economy and transforms the current construction practices for builders of manufactured and modular homes in the US.

In some embodiments, the workflow described herein (and depicted in FIG. 5) may be an algorithm or software component that is stored in memory and executed by a hardware processor. For example, FIG. 8 is a diagram illustrating an example system 301 for designing a construction component for a building. Referring to FIG. 8, system 301 includes one or more processor(s) 302, a memory 304, a storage device 306 communicatively connected via a system bus 308. In some embodiments, processor(s) 302 can include a microprocessor, central processing unit (CPU), or any other like hardware-based processing unit. In some embodiments, a construction component design (CCD) manager 310 can be stored in memory 304, which can include random access memory (RAM), read only memory (ROM), optical read/write memory, cache memory, magnetic read/write memory, flash memory, or any other non-transitory computer readable medium. In some embodiments, processor(s) 302 and memory 304 can be used to execute and manage the operation of CCD manager 310. In some embodiments, storage device 306 can include any storage medium or storage unit that is configured to store data accessible by processor(s) 302 via system bus 308. Example storage devices can include one or more local databases hosted by system 301.

The design-to-fabrication workflow described above with reference to FIG. 5 may be embodied in the CCD manager 110. CCD manager 310 may be any suitable entity (e.g., software executing on processor(s) 302) for providing one or more aspects associated with preparing, analyzing, interpreting, and/or viewing a construction component, or design thereof, using biomimetic topology optimization. In some embodiments, CCD manager 310 may be configured (e.g., using logic or software) for preparing, analyzing, interpreting, and/or viewing a construction component, or design thereof, using biomimetic topology optimization, e.g., via a graphical user interface (GUI) and/or a visualization for providing visual design clarity for manual review, as needed.

In some embodiments, CCD manager 310 may be configured for analyzing, interpreting, and/or viewing the boundary conditions upon which an optimal material distribution can be based within a design space. In some embodiments, CCD manager 310 may execute one or more algorithms for performing one or more methods or variations described herein.

In some embodiments, CCD manager 310 may include or utilize an algorithm for designing a construction component for a building. In such embodiments, the algorithm may calculate the optimal material distribution within a model volume boundary to meet a particular set of performance goals to maximize the performance of the structural system. For example, CCD manager 310 may identify a material distribution that increases stiffness while reducing the weight by reserving material only in areas of high stress. In another example, CCD manager 310 may use a formula or algorithm to implement one or more biomimetic principles found in nature.

### Definitions

The terminology used herein is for the purpose of describing particular embodiments only and is not intended to be limiting of the presently disclosed subject matter.

While the following terms are believed to be well understood by one of ordinary skill in the art, the following definitions are set forth to facilitate explanation of the presently disclosed subject matter.

All technical and scientific terms used herein, unless otherwise defined below, are intended to have the same meaning as commonly understood by one of ordinary skill in the art. References to techniques employed herein are intended to refer to the techniques as commonly understood in the art, including variations on those techniques or substitutions of equivalent techniques that would be apparent to one skilled in the art. While the following terms are believed to be well understood by one of ordinary skill in the art, the following definitions are set forth to facilitate explanation of the presently disclosed subject matter.

In describing the presently disclosed subject matter, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Following long-standing patent law convention, the terms “a”, “an”, and “the” refer to “one or more” when used in this application, including the claims. Thus, for example, reference to “a cell” includes a plurality of such cells, and so forth.

Unless otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value or to an amount of a composition, mass, weight, temperature, time, volume, concentration, percentage, etc., is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

The term “comprising”, which is synonymous with “including” “containing” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

It will be understood that various details of the presently disclosed subject matter may be changed without departing from the scope of the presently disclosed subject matter. Furthermore, the foregoing description is for the purpose of illustration only, and not for the purpose of limitation.

The present subject matter can be embodied in other forms without departure from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter.

What is claimed is:

1. A method of designing a construction component for a building, the method comprising:
generating a building design that includes one or more construction component; and
applying a biomimetic topology optimization algorithm to the building design to define a structure of the one or more construction component.

2. The method of claim 1, wherein applying a biomimetic topology optimization algorithm comprises applying a numerical method for determining optimal material distribution.

3. The method of claim 1, wherein applying a biomimetic topology optimization algorithm comprises iteratively removing material from areas in which stress is below a predetermined threshold value, wherein the areas are identified based on one or more of a defined boundary volume, load case definitions, and design constraints.

4. The method of claim 1, further comprising fabricating the one or more construction component using an additive manufacturing method.

5. The method of claim 4, further comprising adding one or more additional construction component to the one or more construction component to provide a subassembly for the building.

6. The method of claim 5, wherein adding the one or more additional construction component comprises fabricating the one or more additional construction component using an additive manufacturing method.

7. The method of claim 5, wherein the one or more additional construction component is added by one or more robotic system.

8. The method of claim 4, wherein the additive manufacturing method employs a recycled additive.

9. The method of claim 8, wherein the recycled additive comprises one or more of a recycled bamboo product or a recycled wood product.

10. A construction component for a building, or design thereof, produced by a method of claim 1.

11. A system for designing a construction component for a building comprising:
at least one processor; and
a computing platform implemented using the at least one processor, the computing platform configured for:
preparing, analyzing, interpreting, and/or viewing one or more construction component, or design thereof, using biomimetic topology optimization.

12. The system of claim 11, further comprising one or additive manufacturing component configured for fabrication of the one or more construction component, wherein the computing platform controls the one or more additive manufacturing component.

13. The system of claim 12, further comprising one or more robotic system for adding one or more additional construction component to the one or more construction component

14. The system of claim 13, wherein the computing platform controls the one or more robotic system.

15. The system of claim 11, wherein the one or more additive manufacturing component employs a recycled additive.

16. The system of claim 15, wherein the recycled additive comprises one or more of a recycled bamboo product or a recycled wood product.

17. A non-transitory computer readable medium having stored thereon executable instructions that when executed by at least one processor of a computer cause the computer to perform steps comprising: preparing, analyzing, interpreting, and/or viewing a construction component, or design thereof, using biomimetic topology optimization.
